(19) United States
(12) Patent Application Publication
(10) Pub. No.: US 2003/0099576 A1
(43) Pub. Date: May 29, 2003

(54) Fibrous self-sealing components

(76) Inventors: Xingguo Li, Peachtree City, GA (US); Richard J. Coppola, Peachtree City, GA (US); Li Yao, Peachtree City, GA (US)

Correspondence Address: PENNIE & EDMONDS LLP, 1667 K STREET NW, SUITE 1000, WASHINGTON, DC, 20006

(21) Appl. No.: 10/237,628

(22) Filed: Sep. 10, 2002

Related U.S. Application Data
(60) Provisional application No. 60/317,978, filed on Sep. 10, 2001.

(51) Int. Cl. B01L 3/02

(52) U.S. Cl. 422/100; 436/174; 73/864.02

(57) ABSTRACT

The invention relates to gas- or liquid permeable materials that seal when exposed to water, and to methods of making such materials. In general, materials of the invention comprise super-absorbent fibers. The invention further relates to devices comprising self-sealing media including, but not limited to, pipette tips.

This application claims priority to U.S. provisional application No. 60/317,978, filed Sep. 10, 2001, the entirety of which is incorporated herein by reference.

### 1. FIELD OF THE INVENTION

The invention relates to gas permeable self-sealing media that seal or become less permeable when exposed to water, methods of making and using such media, and devices made from or comprising such media.

### 2. BACKGROUND OF THE INVENTION

2.1. Self-Sealing Media

Self-sealing media are gas- or liquid-permeable materials that become less so when exposed to a particular substance. Typical self-sealing media prevent or inhibit the passage of gas or liquid when contacted with an aqueous liquid or vapor, and are of great utility in a variety of filtering and venting applications. One application is the venting of air from syringes. The use of a self-sealing vent in this case can allow the expulsion of air from a syringe while preventing the expulsion of its contents, which may be hazardous. Another application is the prevention of sample overflow in pipettes. Other potential applications of self-sealing media include, but are not limited to, ventilation of liquid storage and/or delivery systems such as intravenous drug delivery systems.

In order for a self-sealing medium to be useful in a wide range of applications, it must respond (i.e., seal) quickly when exposed to water, cause little or no contamination of aqueous solutions with which it comes in contact, and be capable of withstanding high back-pressures (e.g., greater than about 7 psi) before again allowing the passage of gas or liquid. If the medium is to be used in medical applications, it may also need to be biocompatible (e.g., free of potentially toxic chemicals).

U.S. Pat. No. 4,340,067 discloses a syringe having a bypass element that allegedly allows the expulsion of air, but prevents the expulsion of blood. The bypass element is made of a hydrophilic material that swells when exposed to water. Although the hydrophilic materials that are disclosed (i.e., porous filter papers and copolymers of polyvinyl chloride (PVC) and acrylonitrile) do absorb water to some extent, they do so too slowly to be of much use in other applications. The use of PVC copolymers in many applications is also limited by the fact that they are made using free-radical processes, and consequently may contain trace amount of initiators, monomers, plasticizers, and other toxic molecules.

U.S. Pat. Nos. 4,924,860, 5,125,415, 5,156,811, and 5,232,669 disclose self-sealing media that operate by a different mechanism. These media are made of a porous plastic impregnated with a hydrophilic material such as carboxyl methyl cellulose (CMC), which forms a viscous, amorphous mass when contacted with water. Unfortunately, because CMC and related materials dissolve in water, they have no structural integrity when wet, and will readily leach from media that contain them. The usefulness of media such as that disclosed by U.S. Pat. No. 5,156,811 is further limited by the length of time it takes for cellulose powders to increase the viscosity of water to a point where sealing occurs. It is also limited by the fact that conventional self-sealing materials such as CMC will only affect the passage of water through pores that contain them. This means, for example, that the majority of the pores of CMC-based self sealing media must contain particles of CMC if sufficient sealing is to occur upon contact with water. Conventional self-sealing media therefore contain as much as 10 to 20 weight percent cellulose powder.

The high cellulose content of conventional self-sealing media causes several problems. For example, it increase the probability that cellulose particles will fall out of media, and contaminate their surroundings. And because conventional self-sealing media must contain such large amounts of sealing material, they must contain a proportionally smaller amount of the plastic matrix that provides the media with structure. This can have an adverse effect on the mechanical strength of the media, especially when wet.

A third type of self-sealing medium is disclosed by U.S. Pat. Nos. 4,769,026 and 5,364,595. This material is made of a porous, hydrophobic plastic that has a small average pore size. It can therefore be used to avoid severe contamination problems associated with cellulose-based self-sealing materials. However, it can withstand only moderate back-pressures before allowing the passage of water.

A fourth type of self-sealing medium is disclosed by International application no. WO02/36708, published May 10, 2002, to Li Yao, et al. That application describes media that comprise particles of super-absorbent material imbedded in a porous thermoplastic matrix. Specific media described are prepared by sintering thermoplastic and super-absorbent particles.

2.2. Super-Absorbent Materials

Materials have been developed during the past ten years that rapidly swell when contacted with water, but do not dissolve in water. These materials, which are referred to herein as “super-absorbent materials,” but which are also known as “superabsorptive polymers,” can absorb large amounts of water and retain their structural integrity when wet. See Tomoko Ichikawa and Toshinari Nakajima, “Superabsortive Polymers,” Concise Polymeric Materials Encyclopedia, 1523-1524 (Joseph C. Salamone, ed.; CRC; 1999).

A variety of super-absorbent materials are known to those skilled in the art. For example, U.S. Pat. No. 5,998,032 describes super-absorbent materials and their use in feminine hygiene and medical articles. Other examples are disclosed by U.S. Pat. No. 5,750,585, which describes a water-swellable, super-absorbent foam matrix, and by U.S. Pat. No. 5,175,046, which discloses a super-absorbent laminated structure. Additional examples of super-absorbent materials include, but are not limited to, those disclosed by U.S. Pat. Nos. 5,939,086; 5,836,929; 5,824,328; 5,797,347; 4,820,577; 4,724,114; and 4,443,515.

### 3. SUMMARY OF THE INVENTION

This invention is directed, in part, to materials that comprise super-absorbent fibers, methods of making such materials, and methods of using them. Specific materials of the invention can be used to provide plugs, vents, and other components that allow the passage of air or other gases, but which seal when contacted with water or aqueous fluids.

One embodiment of the invention encompasses a fiber blend comprising a super-absorbent fiber and secondary fiber, wherein the secondary fibers are not super-absorbent.

Another embodiment of the invention encompasses a method of inhibiting the flow of an aqueous liquid from a cavity having an interior and exterior which comprises disposing a self-sealing material between the interior and exterior of the cavity, wherein the self-sealing material comprises super-absorbent fibers.

Still another embodiment of the invention encompasses a pipette tip which comprises: a hollow tube open at opposite first and second ends; a center member disposed between said opposite first and second ends; and a means for attaching the first end of the hollow tube to a suction device; wherein said center member comprises super-absorbent fibers.

3.1. Definitions

As used herein and unless otherwise specified, the term “fiber,” means as any thread-like object or structure with a high length-to-width ratio and with suitable characteristics for being processed into a fibrous materials. Fibers can be made of materials including, but not limited to, synthetic or natural materials.

As used herein and unless otherwise specified the term “staple fibers” means fibers cut to specific lengths.

As used herein and unless otherwise specified the term “bicomponent fiber” means a fiber combining segments of two differing compositions, generally side-by-side or one inside another (core and sheath).

As used herein and unless otherwise specified the term “super-absorbent fiber” means a fiber made from a super-absorbent polymer or comprising a super-absorbent material. Specific super-absorbent fibers are fibers made from super-absorbent polymers. Specific super-absorbent fibers are substantially free (e.g., contain less than about 10, 5, 1, or 0.5 weight percent) of materials that are not super-absorbent.

It should be noted that when the term “about” is used before a series of numbers, it is to be construed as applying to each of those numbers. For example, the phrase “about 10, 20, or 30” means the same as the phrase “about 10, about 20, or about 30.”

### 3.2. BRIEF DESCRIPTION OF THE DRAWINGS

Aspects of specific embodiments of the invention can be understood with reference to the figures described below:

FIG. 1A illustrates a pipette tip of the invention;

FIG. 1B illustrates a pipette of the invention;

FIG. 1C illustrates a top view of a pipette tip of the invention; and

FIG. 1D illustrates a second pipette tip of the invention.

### 4. DETAILED DESCRIPTION OF THE INVENTION

This invention relates to materials that can be used in a variety of applications. Specific materials of the invention are self-sealing media that are permeable to gases or non-aqueous liquids but which seal, or become less permeable, when exposed to aqueous liquids or vapors. Preferred materials of the invention exhibit one or more properties that make them particularly suited for self-sealing applications. Examples of such properties include, but are not limited to, rapid aqueous fluid swelling, good flexibility, high loading of the super-absorbent fibers, minimal water solubility, and minimal migration of swollen gel formed upon the contact of the super-absorbent fibers with water. Examples of such applications include, but are not limited to, pipette tip filters and other applications disclosed in U.S. patent application Ser. No. 09/699,364, filed Oct. 31, 2000 by Li Yao, et al., which corresponds to International application no. WO02/36708, published May 10, 2002, both of which are incorporated herein by reference.

Materials of the invention comprise super-absorbent fibers optionally combined with what are referred to herein as “secondary fibers.” Examples of secondary fibers are fibers that are not made of a super-absorbent material, that increase the wet strength of the materials, and/or that reduce the migration of super-absorbent gel, which may form when super-absorbents are contacted with water. Specific materials of the invention comprise about 100, 90, 80, 70, 60, 50, 40, 30, 20, 10, 5, or 1 weight percent super-absorbent fiber and about 0, 10, 20, 30, 40, 50, 60, 70, 80, 90, 95, or 99 weight percent secondary fiber(s). Particular materials of the invention comprise about 40 to about 95 weight percent super-absorbent fiber.

Specific embodiments of this invention encompass functional fibers and fibrous materials made using binder fibers, as described in U.S. application Ser. No. 09/838,200, filed Apr. 20, 2001 by Li Yao, et al., the entirety of which is incorporated herein by reference, wherein what is referred to in that application as the “functional fiber” is a super-absorbent fiber. However, many materials of this invention are not made by sintering; i.e., they do not contain binder fibers or other materials that are sintered to super-absorbent fibers.

4.1. Super-Absorbent Fibers

Self-sealing media of the invention comprise super-absorbent fibers, which rapidly swell when they absorb water, but which are not readily soluble in water. Specific super-absorbent materials from which super-absorbent fibers can be made are capable of absorbing greater than about 100, 200, 500, or 1000 percent of their weight in water while maintaining their structural integrity. Consequently, and without being limited by theory, when specific materials of the invention are contacted with water (either in the form of a liquid or vapor), the super-absorbent fibers they contain swell to block and/or inhibit the passage of gases through them.

When contacted with water, super-absorbent materials swell to form gels. Most super-absorbent polymers currently used are sodium acrylate-based polymers which have a three dimensional network-like molecular structure. Small amounts of crosslinkers play a major role in modifying the properties of superabsorbent polymers. The type and quantity of crosslinkers control both the swelling capacity and gel modulus. Other suitable water swelling materials are natural-based super-absorbent fibers such as, but not limited to, crosslinked polysaccharides or modified cellulose products. Still other super-absorbent materials that can be used to provide fibers useful in particular embodiments of this invention are described below, as are various fabric forms of such fibers.

4.1.1. Acrylic Acid Based Fibers

Super-absorbent fibers can be made from ethylenically unsaturated carboxylic monomers and copolymerizable ethylenically unsaturated monomers. These fibers are formed by extruding a solution or dispersion of the polymeric material in a solution of the secondary matrix copolymer in its non-crosslinked state into a gaseous environment wherein solvent is removed to form the fiber, and subsequently crosslinking the matrix copolymer. See, e.g., U.S. Pat. Nos. 5,466,733 and 5,607,550, and European patent application 268498, each of which is incorporated herein by reference. This technology has been used by Oasis Technical Absorbents Ltd, UK and Camelot (Canada).

One example of fibers made by this method are fibers of polysodium acrylate, the structure of which is shown below:

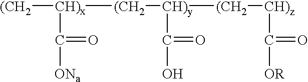

wherein x, y and z represent mole fractions of the moieties in the polymer chain, and the sum of x, y and z is 1.0. R is a substituent, such as alkyl, and Nₐ is an amine, such that particular fibers contain acrylate and acrylic acid moieties distributed along the polymer chain.

4.1.2. Bi-layer Hydrolyzed Polyacrylonitrile Salt Fibers

Another example of super-absorbent fibers that can be used in this invention are core/sheath structure bicomponent fibers, wherein the sheath is an outer layer of hydrolyzed polyacrylonitrile salt, such as, but not limited to, polysodium acrylate or polyammonium acrylate, and the core is polyacrylonitrile. Examples of such fibers include LANSEAL F, (Toyobo, Japan), which has a core made of acrylic fiber and a sheath made of polyacrylate superabsorbent. In specific fibers, the outer layer swells to about 12 times in diameter by imbibing water.

The molecular formula of particular hydrolyzed polyacrylonitriles is shown below:

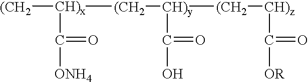

where x, y, and z represent mole fractions of the moieties in the polymer chain, and the sum of x, y, and z is 1.0. R is substituent, such as alkyl, such that functional moieties bound to the polymer include, but are not limited to, ammonium acrylate, acrylic acid, and un-hydrolyzed acrylonitrile.

4.1.3. Fiber and Super-absorbent Particle Blend

Other super-absorbent fibers that can be used in the invention are made of thermoplastic polymeric fibers and super-absorbent particles, which can be attached to the thermoplastic fibers by thermobonding. For example, they can be bonded by heating the polymeric fiber to a temperature at which adhesion is obtained between the fiber and the super-absorbent particles. See, e.g., U.S. Pat. No. 6,194,630, which is incorporated herein by reference.

4.1.4. Hydrolyzed Polysuccinimide

Another type of super-absorbent fiber comprises partially hydrolyzed, internally plasticized, crosslinked, superabsorbing fibers derived from polysuccinimide fiber. See, e.g., U.S. Pat. Nos. 6,150,495 and 5,997,791, both of which are incorporated herein by reference. The crosslinked hydrolyzed polysucinimide fibers are made of polyamide containing at least three divalent or polyvalent moieties distributed along the polymer chain, having the following formulas:

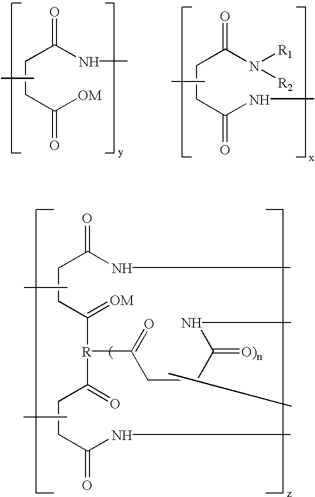

wherein M represents alkali metal cation, ammonium or quaternary ammonium, R represents a divalent or polyvalent crosslinker moiety, x, y and z represent mole fractions of the moieties in the polyamide and are respectively about 0.01 to about 0.20; about 0.60 to about 0.90 and about 0.01 to 0.30 wherein the sum of x, y and z is 1.0, and n is an integer varying independently from 0 to 4. R₁ and R₂ are substituents on the monoamine compound used for the internal plasticization of polysuccinimide, and can be the same or different.

4.1.5. Nonwoven Wet-laid Superabsorbent Materials

Other super-absorbent materials that can be used in various embodiments of this invention are disclosed in European patent application 437816, which is incorporated herein by reference. These fibers are provided as a nonwoven wet-laid superabsorbent material produced by the process of blending superabsorbent polymer particles, and drying the superabsorbent slurry/fibre mixture to form a nonwoven wet-laid superabsorbent material.

Still other materials that can be used in this invention are disclosed in European patent application 359615, which is also incorporated herein by reference. That application discloses a method for the manufacture of a superabsorbent fibrous structure in which a dry solid absorbent is applied directly to a wet-laid web of cellulosic fibers prior to drying the wet web.

4.1.6. Other Fibers and Their Selection

Specific examples of super-absorbent materials that can be provided as fibers and used in various embodiments of this invention include, but are not limited to, hydrolyzed starch acrylonitrile graft copolymer; neutralized starch-acrylic acid graft copolymer; saponified acrylic acid ester-vinyl acetate copolymer; hydrolyzed acrylonitrile copolymer; acrylamide copolymer; modified cross-linked polyvinyl alcohol; neutralized self-crosslinking polyacrylic acid; crosslinked polyacrylate salts; neutralized crosslinked isobutylene-maleic anhydride copolymers; and salts and mixtures thereof.

Other super-absorbent materials that can be used in the invention include, but are not limited to, those disclosed by U.S. Pat. Nos. 6,433,058; 6,416,697; 6,403,674; 6,353,148; 6,342,298; 6,323,252; 6,319,558; 6,194,630; 6,187,828; 6,046,377; 5,998,032; 5,939,086; 5,836,929; 5,824,328; 5,797,347; 5,750,585; 5,175,046; 4,820,577; 4,724,114; and 4,443,515, each of which is incorporated herein by reference. Additional examples include, but are not limited to: treated polyacrylonitrile fibers (e.g., fibers treated with metal hydroxides or ammonia); crosslinked partially neutralized maleic anhydride copolymer spun fibers; polyacrylonitriles co-spun with superabsorbent polymers such as acrylate/acrylonitrile copolymers; crosslinked polyacrylate and copolymer fibers, such as those described in Japanese Patent No. 89/104,829, which is incorporated herein by reference; fiber flocks containing super-absorbents as described in U.S. Pat. No. 5,002,814, which is incorporated herein by reference; and polyoxyalkylene glycol fibers, such as those described in U.S. Pat. No. 4,963,638, which is incorporated herein by reference. Natural-based superabsorbent fibers such as, but not limited to, crosslinked polysaccharides and modified cellulose products can also be used in certain embodiments of the invention, as can cellulosic-based superabsorbents. Examples of preferred super-absorbent fibers are LANSEAL (Toyobo, Japan); N-38 type 101, type 102, type 121 and type 122 (Oasis Technical Absorbents, UK); and Camelot 808, 908, and FIBERSORB (Arco Chemicals).

Table 1 lists several other commercially available superabsorbent fibers that can be used in various embodiments of this invention, as well as some of their relative features:

TABLE 1
Superabsorbent Fibers

| | | Flexibility | Wet | |
|---|---|---|---|---|
| Manufacturer | Material | Gel | Strength | Migration |
| Toyobo | SAP coated on | Very Good | Low | High |
| | acrylic fiber | | | |
| Oasis | Polyacrylate | Poor | Medium | Low |
| Technical | | | | |
| Absorbents | | | | |
| Camelot | Polyacrylate | Good | High | Low |

It will be apparent to those skilled in the art that the selection of super-absorbent material(s) for use in a material of the invention will depend on a variety of factors, including the physical and chemical properties of the material. For example, factors to be considered when selecting a super-absorbent material include, but are not limited to, the amount of water it can absorb, its rate of water absorption, how much it expands when it absorbs water, its solubility in non-aqueous solvents with which it may come into contact, its thermal stability, and its biocompatibility.

The physical and chemical properties of a super-absorbent material depend, at least in part, on the physical and chemical properties of the specific molecules from which it is made. For example, the bulk properties of a super-absorbent material made from a particular polymer can depend on the average molecular weight and hydrophilicity of that polymer. The bulk properties of the super-absorbent material can further depend on the amount and type of crosslinking that holds the polymers together.

Crosslinking can be of at least two types, and mixtures thereof. A first type is covalent crosslinking, wherein polymers are covalently attached to one another by methods well known in the art. A second type is physical crosslinking, wherein polymers are associated by hydrogen bonding, ionic bonding, or other non-covalent interactions, which can provide crystalline or semi-crystalline super-absorbent materials. Super-absorbent materials that are covalently crosslinked are typically more durable than physically crosslinked materials, but often contain chemical residues from the crosslinking process. Consequently, chemically crosslinked super-absorbent materials may not be suitable for use in applications wherein the leaching of such residues must be avoided.

The durability and toughness of super-absorbent materials typically increase with increased crosslinking. However, the ability of super-absorbent materials to rapidly expand and absorb water can decrease with increased covalent crosslinking. For example, sodium polyacrylate-based super-absorbent materials contain long, interwoven polymer chains having a number of ionic functional groups. When contacted with water, the ionic functional groups disassociate to provide an ionized polymer network. Swelling of the material occurs as ionic crosslinking is eliminated, and is accelerated due to repulsions between anions bound to the polymeric chain. As the material swells, large void volumes are created, which can accommodate the absorption of water until the polymer matrix can no longer expand. The scale of expansion is determined, at least in part, by the degree of crosslinking. Without intermolecular crosslinking, super-absorbent materials would expand infinitely; i.e., they would dissolve.

The degree to which a super-absorbent material absorbs water is related to the concentration of ionic functional groups and crosslinking density in it. In general, water absorption increases with an increased concentration of ionic functional groups and/or a decrease in crosslinking density. Of course, when particles or inclusions of super-absorbent material are trapped within the porous matrix of a self-sealing material, their expansion is also restricted by the matrix surrounding them.

4.2. Secondary Fibers

Secondary fibers can be combined with super-absorbent fibers to provide specific materials of the invention. Secondary fibers can be used for a variety of reasons such as, but not limited to, lowering the cost of the final products, increasing their wet and dry strength, and increasing their ability to prevent migration of wet super-absorbent material.

Secondary fibers can be staple monocomponent fibers and/or staple bicomponent fibers. Examples of monocomponent fibers include, but are not limited to, polyethylene (PE), polypropylene (PP), polystyrene (PS), nylon-6, nylon-6,6, nylon12, copolyamides, polyethylene terephthalate (PET), polybutylene terephthalate (PBT), copolyester (CoPET), and cellulose based fibers, such as rayon and Tencel. Examples of suitable bicomponent fibers include, but are not limited to, PE/PET, PP/PET, CoPET/PET, PE/Nylon, PP/Nylon, Nylon-6,6/Nylon-6.

Other fibers that can be used as secondary fibers are disclosed in U.S. application Ser. No. 09/838,200, filed Apr. 20, 2001 by Li Yao, et al., the entirety of which is incorporated herein by reference.

4.3. Formulation and Manufacture

Materials of the invention can be made using well known methods of making yarns. See, e.g., U.S. Pat. No. 6,319,558, which is incorporated herein by reference. Examples of methods known and used in the textile industry include, but are not limited to, blending, carding, drawing, reducing, spinning, single end winding, final winding and twisting. Materials of the invention can also be made using wet-laid and other techniques used in the industry to make, for example, paper (e.g., filter paper). See, e.g., European patent application nos. 437816 and 359615, both of which are incorporated herein by reference.

The structures of fibers made and/or used in various aspects of the invention include, but are not limited to, sheath/core, island-in-sea, and side-by-side multi-component construction. See, e.g., U.S. application Ser. No. 09/838,200, filed Apr. 20, 2001 by Li Yao, et al., the entirety of which is incorporated herein by reference.

One or more different types of superabsorbent fibers can be used to provide a material of the invention in addition to one or more optional secondary fibers. Generally, the total amount of super-absorbent fiber in a material of the invention ranges from about 5 to about 99 weight percent, preferably about 40 to about 95 percent. Materials of the invention can further comprise other optional materials such as, but not limited to, finishing agents and dyes. Examples of finishing agents include, but are not limited to, surfactants, lubricants, softeners, antistats, and other finishing agents, such as, antioxidants, antimicrobials. Surfactants and lubricants, include, but are not limited to, Tween-20® and Afilan® (fatty acid polyglycol ester). The relative amounts of these materials will be readily apparent to those skilled in the art, but typically range from about 0.005 to about 1 weight percent, more preferably from about 0.01 to about 0.75 weight percent, and most preferably from about 0.015 to about 0.5 weight percent of the mixture from which a material of the invention is prepared.

Preferred super-absorbent and secondary fibers are staple fibers. Examples of specific staple lengths of include, but are not limited to, those in the range of about 5 mm to about 80 mm. Other specific lengths are greater than about 25 mm. Examples of super-absorbent and secondary fiber diameters include, but are not limited to, from 1.0 to about 20 denier, preferred from about 2.0 to about 10 denier.

4.4. Self-Sealing Devices

In a specific embodiment of the invention, a fiber blend in the form of sliver or yarn is fabricated, cut into a specific length, and plugged in a water or aqueous solution transfer device at its top end, such as a serological pipette or disposable pipette tip. The self-sealing functionality of fiber blend protects the liquid transfer device (pipetter or pipetting device) from contamination when the transferred liquid is overdrawn.

The invention can be applied to prevent sample fluid contamination of the pipetting mechanism (pipetter) caused by overdrawing serological pipettes and pipette tips. Mouth pipetting, while common in the past, is a discouraged laboratory practice. However, this invention prevents overdrawing fluid into the mouth if the fluid were overdrawn by a someone who is not following recommended practice. The self-sealing fiber component forms an effective barrier to continued air or liquid flow in any liquid dispensing device in the event that it is contacted by an aqueous solution. The invention can also be applied to oil/water separation and other water leakage protection devices. See, e.g., U.S. patent application Ser. No. 09/699,364, filed Oct. 31, 2000 by Li Yao, et al., which corresponds to International application no. WO02/36708, published May 10, 2002, both of which are incorporated herein by reference.

There are several common and well known methods in which to insert fiber plugs into tubular devices. One such method in which superabsorbent fiber can be inserted into a simple thermoplastic pipette is using a jacketed funnel/ push rod insertion assembly. Using this assembly, a jacketed funnel fixture is placed over the top rim of a pipette tube. At this point, the blended, superabsorbent fiber sliver is either machine fed into a single funnel fixture or pulled across the top of a series of fixtures aligned in a row. Once positioned inside the fixture or across the top of a series of fixtures, the fiber sliver is cut using a cutting or pinching mechanism into a specified length forming a loose, unbound plug of material. Once the fiber has been positioned inside or above the funnel fixture and cut into the proper length, the plug can be inserted into the pipette in a number of ways which include, but not limited to: being pushed into the pipette with a blunted end push rod, being pushed into the pipette with a hooked or barbed push rod, being blown into the pipette using high pressure gas jets, being pulled into the pipette using a vacuums.

When using a blunted, barbed, or hooked push rod, the insertion depth is easily controlled by controlling the penetration depth of the probe. In some cases, especially when using high pressure gasses or vacuum to insert the fiber plug, it may be desirable to use a trap to catch the fiber plug and control the insertion depth of the fiber plug.

### 5. EXAMPLES

Some specific examples of materials, devices, and methods of the invention are provided below. These examples are not intended to limit the scope of the claimed invention.

### 5.1. Example 1

### Fiber Formulations

Specific fiber formulations that can be used to provide materials of the invention are listed in Table 2:

TABLE 2
Fiber Formulations

| | Super-absorbent Fiber | Secondary Fiber |
|---|---|---|
| 1 | Toyobo N-38, 100%(wt), 38 mm¹, | |
| | 2.5 denier² | |
| 2 | Toyobo N-38, 80%(wt), 38 mm¹, | Polyester, 20%, 52 mm¹, |
| | 2.5 denier² | 3.0 denier² |
| 3 | Toyobo N-38, 90%(wt), 51 mm¹, | Polypropylene, 10%, 38 mm¹, |
| | 5.0 denier² | 3.0 denier² |
| 4 | Toyobo N-38, 80%(wt), 51 mm¹, | Rayon, 20%, 52 mm¹, |
| | 5.0 denier² | 3.0 denier² |
| 5 | Camelot 908, 70%, 52 mm¹, | Rayon, 30%, 52 mm¹, |
| | 10 denier² | 3.0 denier² |
| 6 | Camelot 808, 70%, 52 mm¹, | Rayon, 30%, 52 mm¹, |
| | 10 denier² | 3.0 denier² |
| 7 | Oasis 102, 80%(wt), 52 mm¹, | Acrylic, 20%, 38 mm¹, |
| | 3.0 denier² | 2.5 denier² |
| 8 | Oasis 122, 90%(wt), 52 mm¹, | Polypropylene, 10%, 38 mm¹, |
| | 3.0 denier² | 3.0 denier² |

Note:
¹fiber staple length,
²fiber diameter.

### 5.2. Example 2

### Pipette Tip

The following example shows how to fabricate self-sealing fiber inserts used for a 5 ml serological pipette. 40 lb of Toyobo N-38 superabsorbent fiber and 10 lb of Fiber Innovation polyester fiber are blended and carded into sliver of 25 grains by a Hollingsworth Mini-Carder. The length of Toyobo N-38 is 51 mm, and its diameter is 5.0 denier. The length of polyester staple is 52 mm, and its diameter is 3.0 denier. The self-sealing sliver is cut into inserts with 25 mm long. One piece of insert is automatically put into the feed guide tube by the part feeder, and then the pusher rod pushes the insert into the loading area of a 5 ml serological pipette.

### 5.3. Example 3

### Pipette Tip

The following is another example showing how to fabricate self-sealing fiber inserts used for a 50 ml serological pipette. 35 lb of Camelot 908 superabsorbent fiber and 15 lb of Acordis Rayon 6150 are blended and carded into sliver of 40 grains by a Hollingsworth Mini-Carder. The length of Camelot 908 is 52 mm, and its diameter is 10 denier. The length of Rayon is 52 mm, and its diameter is 3.0 denier. The self-sealing sliver is cut into inserts with 40 mm long. One piece of insert is automatically put into the feed guide tube by the part feeder, and then the pusher rod pushes the insert into the loading area of a 50 ml serological pipette.

### 5.4. Example 4

### Pipettes and Pipette Tips

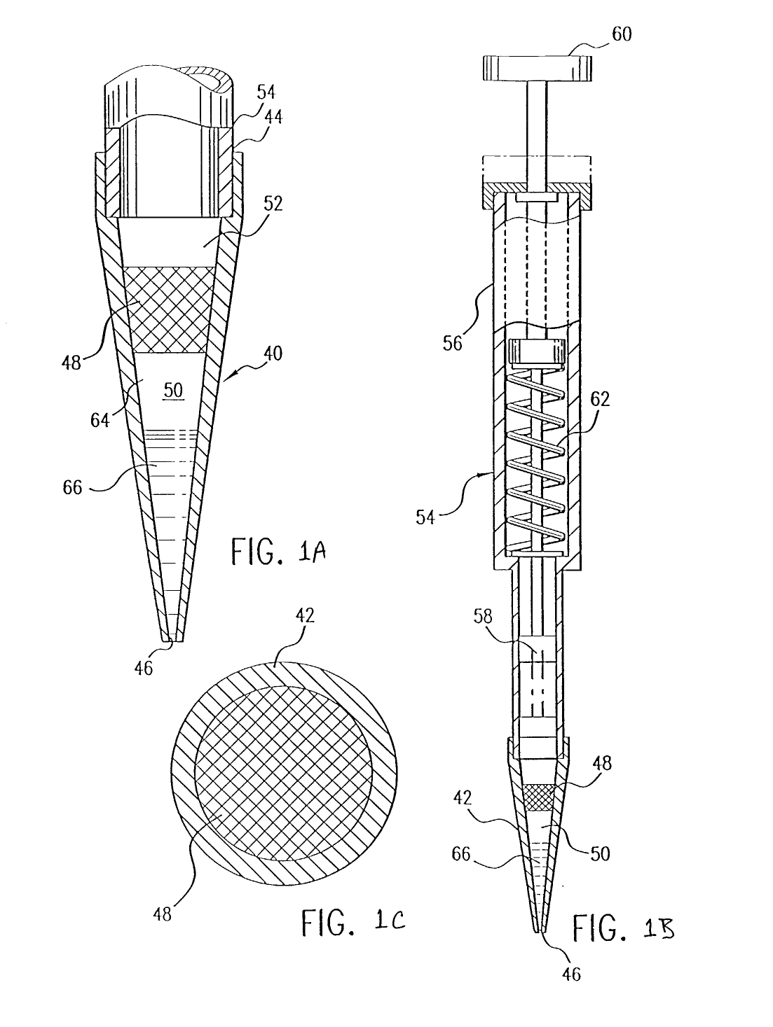

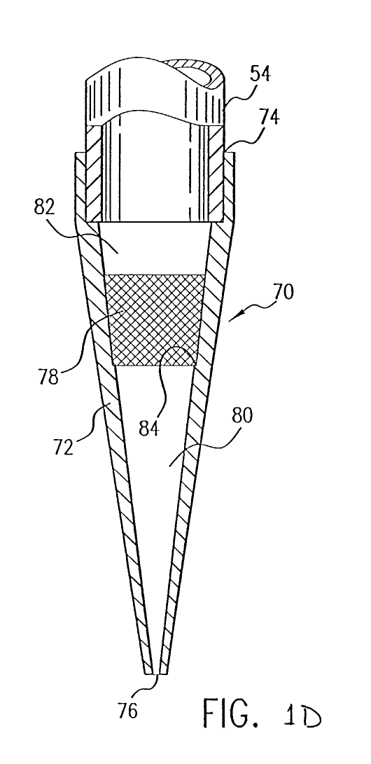

FIGS. 1A to 1D illustrate pipette and pipette tips of the invention. FIGS. 1A and 1B illustrate a pipette tip 40 for drawing and dispensing liquid samples. The pipette tip 40 basically comprises a tapering, hollow tubular member 42 of non-reactive material such as glass, open at its opposite first 44 and second 46 ends and a plug member 48 of the self-sealing medium of the invention disposed in the tubular member 42 to define a liquid sample chamber 50 between the plug member 48 and second end 46 of the tube. The plug member is also spaced from the first end 44 of the tube to define an air barrier or chamber 52 between the plug member and end 44 of the tube.

The first end 44 of the tubular member 42 is releasably secured to a suitable suction device 54 in a manner known in the field, as generally illustrated in FIG. 1B. Any suitable suction device for drawing a predetermined volume of liquid into the chamber 50 can be used, such as the volumetric pipettor illustrated in the drawings, or a suction pump, elastic bulb, bellows, or the like as are commonly used to draw liquids in the laboratory analysis field. The suction device 54 illustrated by way of example in FIG. 1B comprises a cylinder or a tube 56 and a piston 58 slidable in tube 56 and attached to a plunger 60 extending out of one end of tube 56 The opposite end of the tube 56 is secured to the first end 44 of the pipette tip 40. Piston 58 is urged upwardly to draw a predetermined volume of liquid equivalent to the piston displacement via return spring 62.

The plug member 48 is preferably force or pressure fitted securely into tube 42, under a sufficient pressure (e.g., about 1800 lb/in²) so that it is securely held and frictionally sealed against the inner wall of tube 42 although not physically attached to the inner wall by any adhesive or other extraneous material. The plug member has a tapering, frusto-conical shape of dimensions matching that of the tube 42 at a predetermined location intermediate its ends, so that the plug member will be compressed as it is forced into the tube and released at the desired position to seal against the inner wall of the tube and define a liquid sample chamber 50 of predetermined dimensions. The liquid sample chamber is arranged to be of predetermined volume greater than the liquid sample volume which will be drawn by one full stroke of the suction device. The dimensions of the chamber 50 beneath plug member 48 are such that there will be a substantial air gap 64 between plug member 48 and a drawn liquid sample 66 to reduce the risk of liquid actually contacting the plug member. The air gap is preferably in the range of from about 10 to about 40 percent of the total volume of chamber 50. Thus, one complete stroke of the suction device will draw only enough liquid to fill from about 60 to about 90 percent of the volume of chamber 50, as indicated in FIG. 1A.

FIG. 1C is a top view of the pipette tip 40. The plug member 48 is formed of a self-sealing medium of the invention that is comprised of super-absorbent fibers and optional secondary fibers.

In order to draw a liquid sample into pipette tube 54, the suction device or plunger is first depressed or compressed, as appropriate, and the tip end 46 is submerged below the surface of a liquid to be sampled. Any aerosol droplets drawn up into plug member 48 will come into contact with super-absorbent fibers, which will absorb the liquid. Other portions of the plug member 48 will still remain unblocked, however, and allow passage of gas through the plug member 48 to draw in and subsequently eject or blow out the sample. As long as the tubular member 42 is held more or less erect and not tilted or bounced during the sampling process, no liquid will come into contact with plug member 48 because the air gap 52 produced by the predetermined volume of sample chamber 50 is substantially greater than the volume of fluid drawn by one stroke of the suction device. When the sample has been drawn, the pipette and attached pipette tip are transferred carefully to a location above a vessel or sample collector into which the liquid sample is to be ejected for subsequent research or analysis. The sample is held in the tube under suction during this transfer procedure. Once the pipette tip is positioned above the collector, the suction device is actuated to blow gas or air back through the plug member and force the liquid sample out of the pipette.

If for some reason the liquid sample 66 actually contacts the plug member during the sampling procedure, sufficient liquid will be absorbed by the self-sealing medium to completely seal the plug member 48 to further passage of gas. Because the self-sealing medium preferably does not contaminate the sample, however, the sample need not be discarded. This is of particular importance when samples contain, for example, material that is extremely expensive or difficult to isolate.

FIG. 1D illustrates a modified pipette tip 70 which again comprises a hollow, frusto-conical or tapering tubular member 72 for securing to a suitable pipette or suction device 54 at one end 74 so as to draw a liquid sample into the pipette through the opposite end 76. A plug member 78 which is of the same material as plug member 48 in the embodiment of FIGS. 1A to 1C is force or friction fitted into the member 72 at an intermediate point between its end so as to define a liquid sample chamber 80 on one side and an air barrier chamber 82 on the opposite side of plug member 78. However, in FIG. 1D the inner wall of member 72 is provided with a step or shoulder 84 against which the plug member 78 is seated and which prevents movement of the plug member any further along the bore of tubular member 72. As in the previous embodiment, the sample chamber 80 has a volume substantially greater than that of a liquid sample drawn by one full stroke of the suction device, so that an air gap will be left between a drawn sample and the plug member. The modified pipette tip 70 operates in the same way as the pipette tip 40 of FIGS. 1A to 1C as described above.

Pipette tips of this invention will greatly reduce the risk of contamination of the pipettor or suction device and resultant cross-over contamination to subsequent samples, and will also substantially reduce the risk to personnel when handling potentially infectious or other hazardous materials. Further, unlike other pipette devices, the self-sealing medium of the invention provides that when a sample does come into contact with the plug member, the sample is not contaminated by, for example, cellulose powder.

The embodiments of the invention described above are intended to be merely exemplary, and those skilled in the art will recognize, or will be able to ascertain using no more than routine experimentation, numerous equivalents of the specific materials, procedures, and devices described herein. All such equivalents are considered to be within the scope of the invention and are encompassed by the appended claims.

What is claimed is:

1. A fiber blend comprising a super-absorbent fiber and secondary fiber, wherein the secondary fibers are not super-absorbent.

2. The fiber blend of claim 1 wherein the blend is a yarn.

3. The fiber blend of claim 1 wherein the blend is a sliver.

4. The fiber blend of claim 1 wherein the super-absorbent fiber is an acrylic acid-based super-absorbent, a bi-layer hydrolyzed polyacrylonitrile salt, a blend of thermoplastic fiber and super-absorbent particles, or a hydrolyzed polysuccinimide.

5. The fiber blend of claim 1 wherein the secondary fibers are staple monocomponent and/or staple bicomponent fibers.

6. The fiber blend of claim 5 wherein the monocomponent fibers are made of polyethylene, polypropylene, polystyrene, nylon-6, nylon-6,6, nylon12, copolyamides, polyethylene terephthalate, polybutylene terephthalate, copolyester, or cellulose based fibers, or combinations thereof.

7. The fiber blend of claim 5 wherein the bicomponent fibers are made of polyethylene/polyethylene terephthalate, polypropylene/polyethylene terephthalate, copolyester/polyethylene terephthalate, polyethylene/Nylon, polypropylene/Nylon, or Nylon-6,6/Nylon-6.

8. A method of inhibiting the flow of an aqueous liquid from a cavity having an interior and exterior which comprises disposing a self-sealing material between the interior and exterior of the cavity, wherein the self-sealing material comprises super-absorbent fibers.

9. The method of claim 8 wherein the super-absorbent fiber is an acrylic acid-based super-absorbent, a bi-layer hydrolyzed polyacrylonitrile salt, a blend of thermoplastic fiber and super-absorbent particles, or a hydrolyzed polysuccinimide.

10. The method of claim 8 wherein the self-sealing material further comprises secondary fibers.

11. The method of claim 10 wherein the secondary fibers are staple monocomponent and/or staple bicomponent fibers.

12. The method of claim 11 wherein the monocomponent fibers are made of polyethylene, polypropylene, polystyrene, nylon-6, nylon-6,6, nylon12, copolyamides, polyethylene terephthalate, polybutylene terephthalate, copolyester, or cellulose based fibers, or combinations thereof.

13. The method of claim 11 wherein the bicomponent fibers are made of polyethylene/polyethylene terephthalate, polypropylene/polyethylene terephthalate, copolyester/polyethylene terephthalate, polyethylene/Nylon, polypropylene/Nylon, or Nylon-6,6/Nylon-6.

14. The method of claim 8 wherein the cavity is a pipette tip.

15. A pipette tip which comprises:
a hollow tube open at opposite first and second ends;
a center member disposed between said opposite first and second ends; and
a means for attaching the first end of the hollow tube to a suction device; wherein said center member comprises super-absorbent fibers.

16. The pipette tip of claim 15 wherein the super-absorbent fiber is an acrylic acid-based super-absorbent, a bi-layer hydrolyzed polyacrylonitrile salt, a blend of thermoplastic fiber and super-absorbent particles, or a hydrolyzed polysuccinimide.

17. The pipette tip of claim 15 wherein the self-sealing material further comprises secondary fibers.

18. The pipette tip of claim 17 wherein the secondary fibers are staple monocomponent and/or staple bicomponent fibers.

19. The pipette tip of claim 18 wherein the monocomponent fibers are made of polyethylene, polypropylene, polystyrene, nylon-6, nylon-6,6, nylon12, copolyamides, polyethylene terephthalate, polybutylene terephthalate, copolyester, cellulose based fibers, or combinations thereof.

20. The pipette tip of claim 18 wherein the bicomponent fibers are made of polyethylene/polyethylene terephthalate, polypropylene/polyethylene terephthalate, copolyester/polyethylene terephthalate, polyethylene/Nylon, polypropylene/Nylon, or Nylon-6,6/Nylon-6.
